(19) United States
(12) Patent Application Publication
(10) Pub. No.: US 2024/0187024 A1
(43) Pub. Date: Jun. 6, 2024

(54) A RADIO TRANSMITTER WITH ADAPTIVE POWER AMPLIFIER AND DIGITAL TO ANALOG CONVERTER CONFIGURATION

(71) Applicant: Telefonaktiebolaget LM Ericsson (publ), Stockholm (SE)

(72) Inventors: Hamed FARHADI, Stockholm (SE); Pål FRENGER, Linköoping (SE)

(73) Assignee: Telefonaktiebolaget LM Ericsson (publ), Stockholm (SE)

(21) Appl. No.: 18/285,062

(22) PCT Filed: Mar. 31, 2021
(86) PCT No.: PCT/EP2021/058442

§ 371 Date: Sep. 29, 2023

(51) Int. Cl. H04B 1/04

(52) U.S. Cl. CPC H04B 1/0475; H04B 2001/0408

(57) ABSTRACT

A method for jointly adapting hardware configurations (c1, c2) of a power amplifier (120), PA, and a digital to analog converter (110), DAC, in a radio transmitter (100). The method comprises obtaining (S1) a transmit signal quality requirement for an upcoming radio transmission, determining (S4) a maximum amount of distortion allowed to be contributed by the PA (120) and by the DAC (110) while meeting the transmit signal quality requirement. and jointly adapting (S5) the hardware configuration (c2) of the PA (120) and the hardware configuration (c1) of the DAC (110) to generate an amount of distortion below the maximum amount of distortion, while improving a secondary objective of the radio transmitter.

### TECHNICAL FIELD

The present disclosure relates to radio transmitters for use in both wired and wireless communication networks. There are disclosed methods and devices for adaptive hardware configuration of a power amplifier (PA) and a digital to analog converter (DAC) in a radio transmitter.

### BACKGROUND

Link adaptation refers to a process performed in a wireless communication system where radio transmission parameters are adjusted to match the current radio propagation conditions. Link adaptation may, for instance, comprise determining a suitable transport block coding and modulation scheme (MCS) based on a transmission link quality, in terms of, e.g., signal-to-noise ratio (SNR) or error-vector-magnitude (EVM) to reach a certain decoding probability at the receiver. Link adaptation is an important component in both single-user (SU) multiple-input multiple-output (MIMO) and multi-user (MU) MIMO systems. In typical SU-MIMO systems, the user equipment (UE) reports back its present channel quality properties which is then applied by the evolved Node B (eNB) when selecting MCS indices for use in upcoming radio transmissions. In MU-MIMO, however, due to the possible interference from other scheduled users, the channel quality at the receivers of course also depend on the set of simultaneously scheduled users.

The 3rd Generation Partnership Project (3GPP) specifies strict minimum EVM requirements for given modulation schemes which must be met. A low EVM allows for use of MCSs associated with higher spectral efficiencies, which is commonly desired.

Hardware impairments will also lead to imperfections in both downlink (DL) transmission and uplink (UL) reception, and these hardware impairments will contribute to the EVM. As an example, it can be expected that a DL transmission will experience a performance degradation due to hardware impairments in the radio frequency (RF) transmitter. Such impairments can include, for instance, power amplifier (PA) nonlinearities, oscillator phase noise, and digital-to-analog converter quantization noise. It is desired to reduce such hardware impairments in order to improve the EVM and thus allow more freedom in selecting MCS indices with higher spectral efficiency.

### SUMMARY

It is an object of the present disclosure to provide improved radio transmitters and corresponding methods, which, among other things, offer better performance while meeting minimum distortion requirements.

This object is at least in part obtained a method for jointly adapting hardware configurations of a power amplifier (PA) and a digital to analog converter (DAC) in a radio transmitter. The method comprises obtaining a transmit signal quality requirement for an upcoming radio transmission and determining a maximum amount of distortion allowed to be contributed by the PA and by the DAC while meeting the transmit signal quality requirement. The method further comprises jointly adapting the hardware configuration of the PA and the hardware configuration of the DAC to generate an amount of distortion below the maximum amount of distortion, while improving a secondary objective of the radio transmitter.

The present disclosure builds on the understanding that the PA and the DAC can be jointly parameterized in a number of different ways, which all reach a transmit signal quality requirement in terms of, e.g., an EVM requirement. Thus, there is room for improvement of a secondary objective, which is likely to vary over the different parameterizations. The methods disclosed herein adjust hardware settings for the PA and for the DAC by, e.g., a joint selection of the PA's operating point and DAC's resolution, to achieve the target hardware quality requirements according to, e.g., standard specifications while attempting to reduce, e.g., overall energy consumption at the transmitter.

According to aspects, the method comprises obtaining a relationship between hardware configuration and corresponding contributed distortion for the PA and for the DAC. The hardware configurations are jointly adapted based on the obtained relationship between hardware configurations and corresponding contributed distortions. There may be multiple pairs of respective hardware configurations of the PA and the DAC meeting the required signal quality requirement. Therefore, jointly adapting the hardware parameters based on the obtained relationship between hardware configurations and corresponding contributed distortions allows for a secondary objective to be improved. Basing the adaptation on the relationship enables a quick method that can be used in real time in the transmitter. Also, the method does not require feedback from the receiver side, which is an advantage.

According to aspects, the method also comprises determining a distortion contribution by one or more non-configurable components in the radio transmitter, i.e., hardware components and sub-systems which are not possible or desired to parameterize, or not possible to parameterize fast enough for the present purpose. The maximum amount of distortion is then determined in dependence of the distortion contribution by the one or more non-configurable components and also in dependence of the transmit signal quality requirement. The overall transmit signal quality requirement budget, e.g., the EVM budget, may be composed of two parts: one part includes the contribution due to impairments from components that can be controlled, and the other part includes the contribution due to impairments that are fixed, i.e., cannot be controlled or may not be easy to control. Splitting the signal quality requirement into such two parts can speed up and facilitate the improvement of the secondary objective, which is an advantage.

According to aspects, the secondary objective comprises any of an energy consumption of the radio transmitter, a data throughput of the radio transmission, an output power of the radio transmission, a spectral efficiency of the radio transmission, and an adjacent channel leakage ratio (ACLR) of the upcoming radio transmission. Improving any of these metrics is highly desirable in many wireless communication systems. In general, any performance metric affected by the hardware configuration of the PA and the hardware configuration of the DAC can be used as the secondary objective. It is also appreciated that the secondary objective may be a weighted combination of different sub-metrics, i.e., the secondary objective may reflect, e.g., both energy consumption and transmit power.

According to aspects, the method comprises obtaining a transmit signal quality requirement comprising an error vector magnitude (EVM) requirement. EVM is a common measure for signal quality, used by, e.g., specifications from 3GPP. Such specifications may specify required EVM values for different modulation schemes. In other words, the transmit signal quality requirement may optionally be determined in dependence of a modulation format of the upcoming radio transmission.

According to aspects, the hardware configuration of the PA comprises a bias and/or an input power associated with the PA. Adapting bias can mean to adapt gate and/or drain bias voltages/currents in a field effect transistor, or, mutatis mutandis, in a bipolar junction transistor. Adapting the input power can be done in many ways, e.g., by a variable attenuator at the input or by controlling the power from the DAC. In general, adapting the hardware configuration of the PA means adapting a parameter affecting the operating point of the PA, which in turn affects the signal quality.

According to aspects, the hardware configuration of the DAC comprises a resolution and/or a sampling rate of the DAC. The resolution of the DAC optionally comprises any of number of quantization bits, least significant bit configuration, and most significant bit configuration. In general, these example hardware configurations of the DAC affects important properties such as consumed energy and generated heat. They may also contribute to a reduction in component life-time. Full scale range (FSR) of the DAC can be another parameter that can be configured. It impacts maximum output signal for the DAC and effectively modifies the power of the input signal to PA.

According to aspects, the hardware configurations are jointly adapted while meeting a minimum requirement of a tertiary objective. According to further aspects, the tertiary objective comprises any of an energy consumption of the radio transmitter, a data throughput of the upcoming radio transmission, an output power of the upcoming radio transmission, a spectral efficiency of the upcoming radio transmission, and an ACLR of the upcoming radio transmission. Other tertiary objectives are also possible. In general, any performance metric affected by the hardware configuration of the PA and the hardware configuration of the DAC can be used as the tertiary objective. Thus, the methods disclosed herein may be used to improve a secondary objective under constraints on a tertiary objective. This feature can be leveraged in order to improve system robustness, which is an advantage.

According to aspects, jointly adapting the hardware configuration of the PA comprises adapting the hardware configuration of the PA based on a behavior model of the PA, where the behavioral model of the PA models distortion contribution by the PA in dependence of the hardware configuration. According to further aspects, jointly adapting the hardware configuration of the DAC comprises adapting the hardware configuration of the DAC based on a behavior model of the DAC, where the behavioral model of the DAC models distortion contribution by the DAC in dependence of the hardware configuration. Behavioral models enable a quick selection of hardware configurations that improve the secondary objective. Also, the behavioral models are not necessarily based on feedback from the receiver side, which is an advantage since it reduces signaling overhead.

According to aspects, any of the behavioral models is further dependent on a signal characteristic of the upcoming radio transmission. In other words, the behavioral model of the PA and/or the behavioral model of the DAC may depend on characteristics such as frequency, bandwidth, MCS indices, power, number of layers, beamforming parameters etc. The behavioral models may further depend on the specific hardware of the DAC and PA, respectively, and the specific hardware of the radio transmitter, e.g., the number of antennas in use at the transmitter. This provides a method that can be adjusted to many different scenarios which is an advantage.

According to aspects, the adapting of the hardware configuration of the PA is based on tabulated data of the PA, where the tabulated data of the PA comprises distortion contribution by the PA for different hardware configurations. According to further aspects, the adapting of the hardware configuration of the DAC is based on tabulated data of the DAC, where the tabulated data of the DAC comprises distortion contribution by the DAC for different hardware configurations. Tabulated data provides an accurate prediction of the distortion contribution and can be obtained with a minimum of assumptions on component behavior. Any of the tabulated data can of course be made dependent on a signal characteristic of the upcoming radio transmission. This provides a method that can be adjusted to many different scenarios which is an advantage.

According to aspects, any of the tabulated data is dynamically updated based on a feedback signal from the radio transmitter. According to further aspects, any of the tabulated data is dynamically updated based on a feedback signal from a remote radio transceiver arranged to communicate with the radio transmitter. This way, the tabulated data can maintain high accuracy even if conditions change, e.g., a change in loading conditions of the PA or in temperature. This can further be used to gather the tabulated data in the first place. A further advantage is an increased resilience to errors in modelling assumptions and so on which otherwise may have an adverse effect on the accuracy of the methods proposed herein.

According to aspects, the method comprises adapting the hardware configuration of the PA based on a feedback signal from the radio transmitter, where the feedback signal comprises a current transmit signal quality. According to further aspects, the method comprises adapting the hardware configuration of the DAC based on a feedback signal from the ratio transmitter, where the feedback signal comprises a current transmit signal quality. This way, the effectiveness of the method is surveyed in real time and the method can be adapted if conditions change. For example, a more conservative distortion contribution of the PA or the DAC can be selected if the signal quality requirement in not met with sufficient margin.

According to aspects, the method comprises jointly adapting a hardware configuration of an oscillator comprised in the radio transmitter to generate an amount of distortion below the maximum amount of distortion, while improving the secondary objective of the radio transmitter. This provides additional means to improve the secondary objective.

There is also disclosed herein computer programs, computer program products, and control units associated with the above-mentioned advantages.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIG. 1 schematically illustrates a radio transmitter,

FIG. 2 schematically illustrates a parameter space under different constraints,

FIG. 3 is a flow chart illustrating methods,

FIG. 4 is a plot showing throughput versus signal to noise ratio of a multi-antenna communication link for different levels of hardware impairments,

FIG. 5 is a flow chart illustrating methods,

FIG. 6 is a contour plot showing EVM requirements for different modulation schemes versus a PA's nonlinearity and versus a DAC's resolution,

FIG. 7 schematically illustrates a communication network,

FIG. 8 schematically illustrates a control unit, and

FIG. 9 shows a computer program product.

### DETAILED DESCRIPTION

Aspects of the present disclosure will now be described more fully with reference to the accompanying drawings. The different devices and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

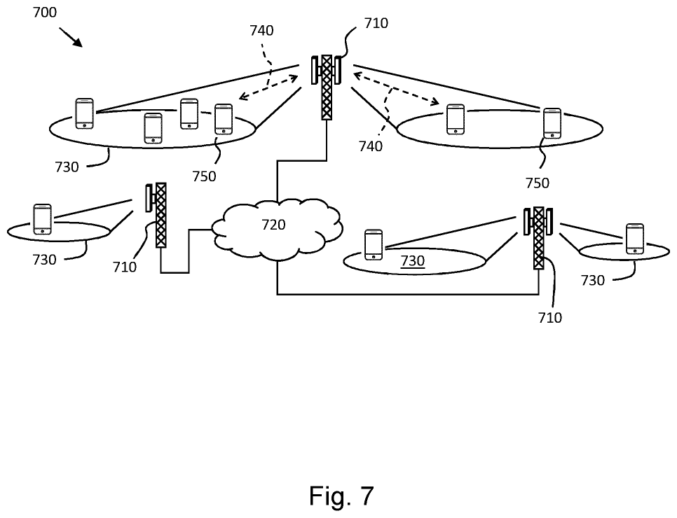

Embodiments herein relate to wireless communication networks and wireless systems in general. However, the embodiments may also be used in wired systems. FIG. 7 schematically illustrates an example communication system 700 comprising radio access network nodes 710 which provide wireless access 740 over a plurality of coverage areas 730. The radio access network nodes are connected to a core network 720. Wireless devices 750 of different types connect to the core network 720 via the radio access network nodes 710.

The communication system 700 may be part of a fifth generation (5G) communication system (5GS) as defined by the 3GPP. However, the techniques disclosed herein are generally applicable, and can be implemented in other communication systems also.

Continuing the discussion above, throughput in a communication system degrades with degrading EVM. An example of this is illustrated in FIG. 4, which shows throughput versus signal to noise ratio (SNR) of a multi-antenna communication link for different levels of hardware impairments. More specifically, the transmitter in the link comprises a PA, and the throughput is studied for the case when the PA is ideal, and for the cases when the PA generates distortion resulting in EVMs of 4%, 6%, and 10%. For an ideal power amplifier, the throughput increases with SNR in a steady and robust way. With increasing the amounts of EVM (2%, 4%, and 10%) the throughput versus SNR performance degrades compared to the ideal case, and eventually flattens out.

In the 3GPP specifications there are requirements for the largest values of EVM that can be tolerated. For instance, 3GPP TS 38.141-2 V16.2.0 (2019-12) specifies the required EVM values for different modulation schemes. As can be seen in the table below, and as expected, lower constellation orders tolerate higher impairment levels. The required EVM values are specified in section 6.6.3.5 of the above-mentioned 3GPP document. For example, for base station (BS) type 1-O, the EVM of each new radio (NR) carrier for different modulation schemes on the physical downlink shared channel (PDSCH) shall be less than the limits in table 6.6.3.5.1-1, which is:

| Modulation scheme for PDSCH | Required EVM (%) |
|---|---|
| QPSK | 18.5 |
| 16QAM | 13.5 |
| 64QAM | 9 |
| 256QAM | 4.5 |

3GPP also specifies other requirements on other kinds of impairment metrics such as for instance adjacent channel leakage ratio (ACLR) and intermodulation distortion (IMD) (as specified in section 6.8 of the above-mentioned 3GPP specification document). ACLR is the ratio of the filtered mean power centered on the assigned channel frequency to the filtered mean power centered on an adjacent channel frequency, and the required ACLR specifications are mentioned in section 6.7.3 of the 3GPP specification.

In existing radio hardware, the total transceiver chain quality is not generally adapted to the requirements of the signal to be transmitted. Instead, prior art solutions optimize individual components, such as adapting the PA bias based on changing peak power and/or peak modulation. However, the total signal error is a composite of many error sources. Optimizing individual components may lead to a transmitter where the total radio performance significantly exceeds the quality requirements of the signal to be transmitted. Such optimization is not efficient since it likely leads to increased power consumption and potentially also an increased heat generation. Some components (such as the DAC) can typically only be adjusted in discrete quality steps (e.g., adding one more bit in DAC resolution decreases the quantization noise with about 3 dB). Other components, such as PAs, have a very non-linear relation between signal error and bias setting.

In other words, by not considering more than one component at a time when adjusting a radio transceiver leads to an inefficient overall operation. This can lead to performance degradation and/or inefficient use of energy and radio resources.

The present disclosure builds on the realization that it is beneficial to jointly adapt hardware configurations of two or more hardware components according to the required transmit signal quality. The distortion that each hardware component generates can then be optimized such that an overall distortion budget can be satisfied, and a desired signal quality can be maintained. The hardware configurations can be jointly tuned such that the generated distortion remains within the budget. The methods disclosed herein adjusts hardware settings for the PA and for the DAC by, e.g., a joint selection of the PA's operating point and DAC's resolution, to archive the target hardware quality requirements according to standard specifications.

The proposed method adapts the distortion budget that can be allocated to each hardware component. The distortion can be quantified using different measures, e.g., EVM. The EVM budget allocation can be performed to improve a secondary performance criterion, i.e., a secondary objective, where the criteria could be for example maximizing throughput or minimizing energy consumption, or a combination of the two.

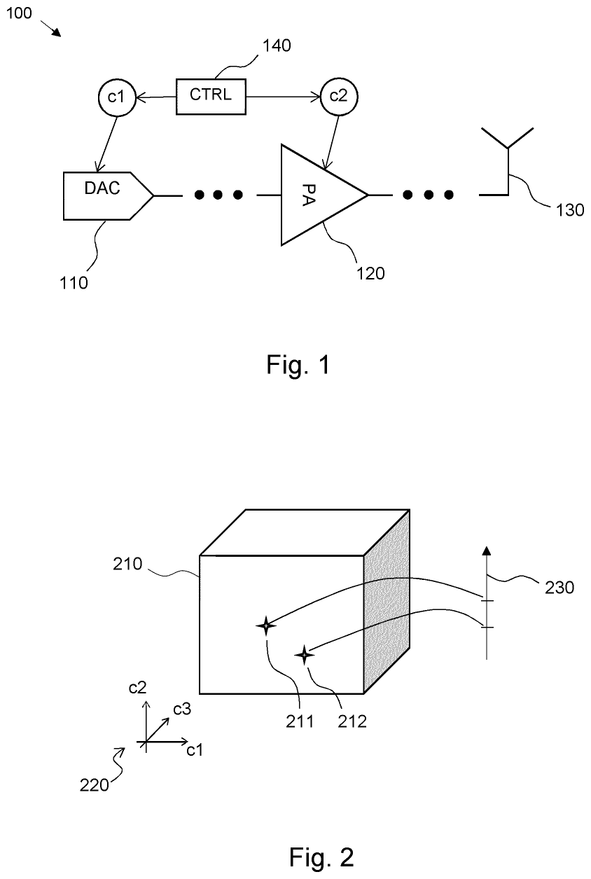

To summarize, with reference to FIGS. 1-3, there is disclosed herein a method for jointly adapting hardware configurations c1, c2 of a PA 120 and a DAC 110 in a radio transmitter 100. The method comprises obtaining S1 a transmit signal quality requirement for an upcoming radio transmission and determining S4 a maximum amount of distortion allowed to be contributed by the PA 120 and by the DAC 110 while meeting the transmit signal quality requirement. The method further comprises jointly adapting S5 the hardware configuration c2 of the PA 120 and the hardware configuration c1 of the DAC 110 to generate an amount of distortion below the maximum amount of distortion, while improving a secondary objective of the radio transmitter.

Using the disclosed method, the link/system performance, such as throughput or energy consumption, is improved by allowing improvement of the secondary objective. The disclosed method further provides flexible hardware that can cope with changing requirements due to a changing environment. For scenarios in which high order modulation is required for transmission, such as in a fixed access wireless network, the adjustment of a DAC's hardware configuration provides an extra opportunity for link adaptation in addition to conventional PA's backoff adjustment methods. Another advantage is that the method does not require feedback of the transmitted signal from the receiver side, which enables a lower delay. However, feedback may still be used for, e.g., redundancy purposes or other reasons, which is discussed in more detail below.

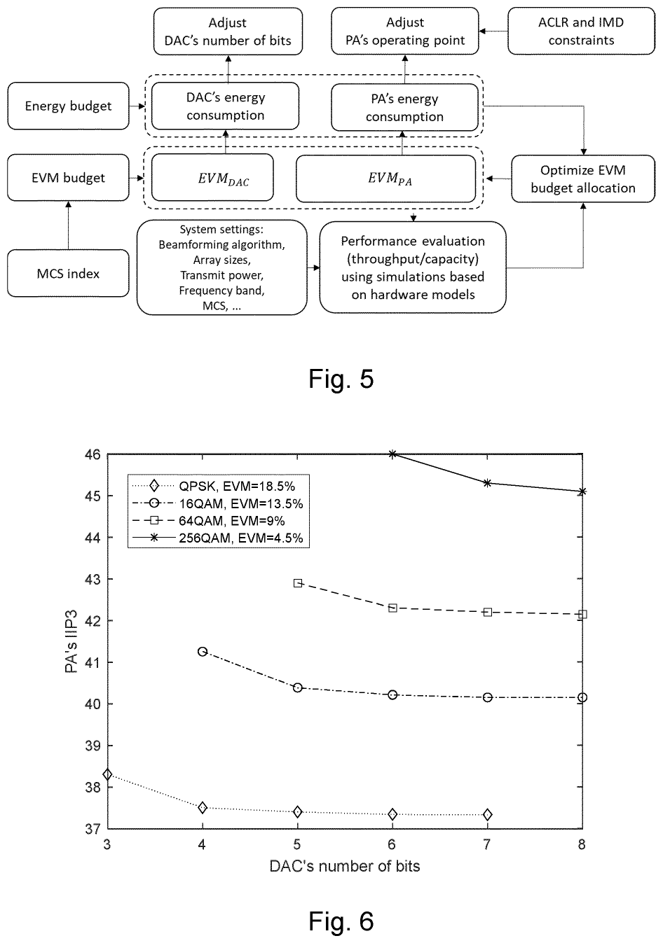

An example embodiment of the herein disclosed methods is depicted in FIG. 5. Here, in a first step, the EVM requirement for the current transmission is obtained. Based on e.g., the current modulation order, bandwidth, number of layers, power, etc. an overall EVM requirement may be determined for example by a table look up operation. Next the current EVM performance of other components for which the EVM performance is not dynamically controlled by this method is determined. The remaining EVM budget is then distributed between the PA and DAC components of the transmitter. Note that the methods disclosed herein are most advantageously used in multi-antenna systems where individual component variations are averaged out to simplify performance prediction.

An example transmitter 100 is shown in FIG. 1. The transmitter comprises a DAC 110, a PA 120, an antenna arrangement 130, and a control unit 140. The transmitter may comprise many additional components such as mixers, oscillators, filters etc. The transmitter may further constitute a part in a transceiver.

The PA 120 in the transmitter 100 can be a general amplification circuit such as class-B amplifier, a chain of sub-amplifiers, a Doherty amplifier, load modulation amplifier, distributed amplifier etc. The PA may further be any type of power transmitter architecture, such as an outphasing transmitter. The PA can have a single or multiple RF inputs, which can be connected to respective sub-DACs comprised in the DAC 110, and/or single or multiple RF outputs, which can be connected to respective antenna ports of the antenna arrangement. The PA may further be a digital amplification circuit.

All such PA architectures comprise a hardware configuration c2 affecting the signal distortion. The hardware configuration c2 of the PA 120 may comprise a bias and/or an input power. Adapting bias can mean to adapt gate and/or drain bias voltages/currents in a field effect transistor, or, mutatis mutandis, in a bipolar junction transistor. Adapting the input power can be done in many ways, e.g., by a variable attenuator at the input or by controlling the power from the DAC. In general, adapting the hardware configuration of the PA means adapting a parameter affecting the operating point of the PA, which in turn affects the signal quality. For example, in a dual RF input PA, the amplitude and phase ratios of the two input signals affect the operating point and can therefore be included in adapting the hardware configuration.

Methods for individually adapting PA bias are known in general. In some radio transmitters, the PA bias is adapted towards changing signal conditions related to peak power, peak modulation, and the number of co-scheduled MIMO streams. In conventional PAs, the energy efficiency is low at the low output power levels, where the PA is operating in the linear region. Therefore, the bias power can be controlled adaptively based on the input power level. For example, first the input power level is detected. Based on that, a low bias current is applied at low input power levels to provide high efficiency, and the bias current then increases adaptively as the input power increases to provide highly linear behavior. A possible implementation of this can be gate voltage control for the PA.

The DAC 110 in the transmitter 100 is a system that converts a digital signal into an analog signal. The DAC comprises a hardware configuration parameter c1 affecting the signal distortion. The hardware configuration of the DAC 110 may comprise a resolution and/or a sampling rate. Furthermore, the resolution of the DAC 110 may comprise any of number of quantization bits, least significant bit configuration, and most significant bit configuration.

In some state-of-the-art radio transmitters, the number of DAC quantization bits is individually adapted towards changing peak power, peak modulation, and the number of co-scheduled MIMO streams. The DAC operation can be adapted by selection of the number of bits (q) and least significant bit to realize a multi resolution DAC. The resolution of the DAC can be adjusted based on a maximum allowed distortion contribution of the DAC. Thus, the energy consumption of the DAC can be reduced by lowering the number of bits when the maximum allowed distortion contribution is large. A system may be composed of multiple DACs with different resolutions, and a resolution selection unit activates only one of the DACs depending on the desired resolution. The activation can be performed for example by turning on the bias current of the corresponding DAC using a switch and measuring the output signal from the output of the corresponding DAC. Another example of an adaptive DAC is a R-2R DAC, where the current sources can be turned off to reduce the resolution of the DAC. Another example is a binary-weighted current-switching DAC architecture. Yet another example is a DAC using a binary-weighted current-steering DAC architecture.

The antenna arrangement 130 in the transmitter 100 can be a single radiation element antenna or an array antenna comprising a plurality of radiation elements. The control unit 140 in the transmitter 100 is arranged to control the jointly adapting S5 the hardware configuration c2 of the PA 120 and the hardware configuration c1 of the DAC 110.

FIG. 2 illustrates a parameter space under different constraints. More specifically, the hardware configurations c1, c2, and c3 define a parameter space 220. These parameters must be selected under a first multidimensional constraint 210, which defines allowed values or value intervals of each hardware configuration, i.e., a primary objective such as a signal quality requirement. The first constraint may be jointly dependent of all hardware configurations, i.e., if one hardware configuration is changed, at least one of the others must also be changed to not affect the constraint criterium (e.g., the signal quality requirement measure). The parameter space may be analyzed only as a function of two hardware configurations c1, c2. The points 211 and 212 represent two selections of the hardware configurations c1, c2, and c3 meeting the first constraint 210. Since there are multiple selections meeting the first constraint, the question of which selection to choose arises. Therefore, the selection presenting the best choice in terms of a secondary objective 230 can be chosen. In other words, any point within the constraint will meet the distortion requirement, but the different points within the constraint may very well give different results when evaluated according to the secondary objective. Thus, a point meeting the constraints can be selected which is associated with an improved, if not optimal, value in terms of the secondary objective.

The disclosed method may furthermore comprise obtaining S11 a transmit signal quality requirement comprising an error vector magnitude (EVM) requirement. The transmit signal quality requirement may alternatively, or in combination of, comprise other distortion metric such as mean square error (MSE) etc. The transmit signal quality requirement may be determined S12 in dependence of a modulation format of the upcoming radio transmission. Such dependency can be determined from a 3GPP specification. In general, the transmit signal quality requirement can be determined in dependence of a signal characteristic of the upcoming radio transmission. Signal characteristic can be, e.g., frequency, bandwidth, MCS indices, power, number of layers, beamforming parameters etc.

The secondary objective may comprise any of an energy consumption of the radio transmitter 100, a data throughput of the radio transmission, an output power of the radio transmission, a spectral efficiency of the radio transmission, and an adjacent channel leakage ratio (ACLR) of the upcoming radio transmission. Improving any of these metrics is highly desirable. Other secondary objectives are also possible. In general, any performance metric affected by the hardware configuration c2 of the PA 120 and the hardware configuration c1 of the DAC 110 can be used as the secondary objective.

The disclosed method may be implemented in a network node or user equipment for real time adaptation of hardware configurations according to transmit signal setting and the operation scenario. The EVM budget allocation to different components can be optimized to improve performance, e.g., by maximizing throughput or minimizing energy consumption or maximizing ACLR, where each of these optimization problems can be solved for a given scenario. Energy consumption minimization can be solved when there are severe energy constraints in the system and thus a low resolution DAC is highly desired. ACLR maximization can be solved in scenarios where there are strict constraints on out of band emission and thus more linear PA operation is desired. Throughput maximization can be solved in scenarios where there are relaxed requirements on out of band emission and energy consumption. The operating scenario can be selected by the scheduler in the wireless communication system.

Hardware impairment models can be used for evaluating the impact of each component on performance. Real time adaptation of hardware configurations can be performed in each scenario based on the scheduler's decision e.g., by selecting a pair of PAs operating point and the number of quantization bits for the DAC. In energy constrained scenarios the lowest feasible resolution of DAC (the one that maintains the EVM requirement) can be selected and the operating point of the PA can be selected accordingly. In scenarios with strict out of band emission requirements, the highest feasible resolution of DAC can be selected, and the operating point of the PA can be selected accordingly, so that the PA is configured to work in a more linear operating point and hence with lower out of band emission. In scenarios with no strict requirements on either out of band emission or energy consumption, the resolution of DAC and the operating point of the PA can be more freely selected such that, e.g., the throughput is improved or even maximized. Transmit signal setting can include modulation and coding (MCS) indices, where the MCS indices can be used to find the corresponding EVM budget using a table or a function (e.g., behavioral model) and finding the corresponding settings for PA (e.g., bias current) and DAC (resolution/number of bits). If different settings of the PA and the DAC result in a given EVM, the selection which achieves an improved throughput or minimizes energy consumption or minimizes the out of band emission is selected according to the scheduler's decision and the operating scenario.

The spectral efficiency of the transmission is largely a consequence of the selected MCS, but other factors such as number of transmit antennas and output power may also have an effect on the spectral efficiency of the transmission.

The methods disclosed herein may comprise obtaining S2 a relationship between hardware configuration and corresponding contributed distortion for the PA 120 and for the DAC 110. In that case, the hardware configurations are jointly adapted S51 based on the obtained relationship between hardware configurations and corresponding contributed distortions. The relationship may be based on respective behavioral models of the PA and the DAC, or on a joint behavioral model. Similarly, the relationship can be based on tabulated data. The behavioral models may be determined based on mathematical analysis, based on computer simulations, or based on a combination of mathematical analysis and computer simulation. Laboratory experimentation may also be used in constructing a behavioral model. Joint behavioral models may be constructed by analyzing two or more components together.

In a similar manner, the joint adaptation of the hardware configuration c2 of the PA 120 may comprise adapting S53 of the hardware configuration c2 of the PA 120 based on a behavior model of the PA. Such behavioral model of the PA models distortion contribution by the PA in dependence of the hardware configuration. As an example, a memory-less nonlinear PA can be modeled by a polynomial model, for example the third-order polynomial expansion as follows

\tilde{x}ₜ(i)=β_{q}xₜ(i)+β₃|xₜ(i)|²xₜ(i),

where xₜ(i) is the input signal to the PA, \tilde{x}(i) is the output signal of the PA, i is an index, and β₁ and β₃ are model parameters. The EVM of the PA can then be specified as a function of input power (P), the number of antennas (M), and the model parameters as follows

EVM_{PA}={square root over (Pₑ_{_{PA}}/P_{in,PA})}×100%=h(β₁,β₃, P, M).

where Pₑ_{_{PA}} is the power of the error vector introduced by the PA and P_{in,PA} is the average symbol power at the input of the PA. The model parameter β₃ depend on the hardware configuration c2 of the PA, such as bias current, and is an indication of how nonlinear the PA is. In an example, based on the behavioral model of PA, where β₁ is approximated to one, the function h can be

$${EVM}_{PA} \approx \sqrt{2} \times \vert {β}_{3} \vert \times \frac{P}{M} \times 100 \%$$

A third-order intercept point (IP3) is an example metric to quantify the third-order intermodulation distortion (IMD3) for nonlinear power amplifiers. It is based on the idea that the PA nonlinearity can be modeled using a polynomial where the coefficients can be derived by means of Taylor series expansion. The third-order intercept point can be obtained graphically by plotting the output power versus the input power on logarithmic scales (e.g., decibels). The graph is composed of two curves: one of them is corresponding to the linearly amplified signal at an input tone frequency, and the other curve is corresponding for the 3^{rd} order nonlinear product. On a logarithmic scale, the function x³ translates into a straight line with slope of 3 dBm/dBm. The linearly amplified signal has a slope of 1, and the curve corresponding to the third-order nonlinear product has a slope of 3. The point where the extended curves intersect is the intercept point. It can be read off from the input or output power axis, leading to input (IIP3) or output (OIP3) intercept point, respectively. A lower intercept point is corresponding to a more nonlinear PA implying that for a larger range of input power the 3^{rd} order intermodulation distortions due to PA nonlinearity can be neglected.

The joint adaptation of the hardware configuration c1 of the DAC 110 may comprise adapting S54 of the hardware configuration c1 of the DAC 110 based on a behavior model of the DAC. Such behavioral model of the DAC models distortion contribution by the DAC in dependence of the hardware configuration. An example behavioral model of the DAC includes parameterization by parameters including the resolution or the number of input bits (q) and the least significant bit (Δ). The covariance of the quantization error can be specified in terms of model parameters and the covariance of the input signal. The covariance matrix can be used to have an estimate of EVM due to DAC quantization noise as follows

EVM_{DAC}{square root over (Pₑ_{_{DAC}}/P_{in,DAC})}×100%=f(q,Δ)

where Pₑ_{_{DAC}} is the power of the error vector introduced by the DAC and P_{in,DAC} is the average symbol power input to the DAC.

Any of the behavioral models may be dependent on a signal characteristic of the upcoming radio transmission. In other words, the behavioral model of the PA and/or the behavioral model of the DAC may depend on characteristics such as frequency, bandwidth, MCS indices, power, number of layers, beamforming parameters etc. The behavioral models may further depend on the specific hardware (e.g., semiconductor technology) of the DAC and PA, respectively, the specific hardware of the radio transmitter 100, e.g., the number of antennas, and environmental factors such as component and ambient temperatures.

In an example embodiment, the hardware configurations are selected using the EVM budget for the corresponding hardware component. The configurations can be selected for example using a function, e.g., a behavioral model, or a table. As an example, FIG. 6 shows a tradeoff between the PA's operating point measured by IIP3 and DAC's number of bits for a given modulation scheme and the corresponding EVM budget according to the standard specifications (3GPP TS 38.141-2 V16.2.0). A larger IIP3 is corresponding to a more linear PA. According to the standard specification, a specific modulation requires the EVM to be lower than a certain threshold. For example, for 256QAM, the EVM needs to be lower than 4.5%. A certain EVM can be attained with different pairs of (IIP3, number of bits) as shown in the figure. For example, all of the three pairs (IIP3, number of bits)=(46, 6), (45.3, 7), (45.1, 8) can lead to 4.5% EVM. This implies that the number of DAC bits can be reduced from 8 bits to 6 bits by having slightly more linear PA. Thus, to use 256QAM, the PA and DAC settings corresponding to each of these pairs can be selected. The selection can be conducted for example based on the criterion that which leads to, e.g., the lowest overall energy consumption, maximum throughput, or maximum ACLR. The hardware configurations can be performed for each modulation scheme and the objectives (e.g., energy consumption minimization, throughput maximization, ACLR maximization) which can be selected based on the scheduler's decision. This implies, for example, changing the resolution of DAC and changing the bias current of PA to new settings.

To be able to transmit signals using a specific modulation, certain EVM requirements need to be satisfied, where EVM is a measure of signal distortions accounting overall signal degradations due to different hardware impairments (e.g., PA nonlinearities, DAC quantization noise, . . . ). The EVM requirements for every modulation scheme are usually specified by the standard. The overall EVM depends on the parameters of the hardware components, where some of these parameters are fixed and depends on the design specification, and some of these parameters are not necessarily fixed (in the conventional systems these may be set to be fixed as well) and can be adapted (e.g., bias current of the PA, and the resolution of DAC) during the operation of the hardware components. To attain certain EVM requirements the signal distortion due to either PA nonlinearities or DAC quantization noise or both can be reduced, by adjusting the operating point of PA via setting its bias current and increasing the resolution of DAC via increasing its number of bits, respectively. Therefore, for every EVM budget (which is corresponding to a possible modulation scheme), there are different possibilities to set PA and DAC parameters as shown in FIG. 6. Each of the curves in this figure is corresponding to a specific EVM budget and the corresponding modulation scheme. Each of the points on each of these curves is corresponding to a specific configuration of PA and DAC. For example, the curve marked with circles is corresponding to 13.5% EVM and three different options for setting PA and DAC parameters and number of bits for DAC can vary from 4 bits to 8 bits given that the PA bias current set, accordingly. Therefore, during the operation of the hardware one of the possible settings can be selected, where the selection can be based on a secondary objective, e.g., to minimize overall power consumption or maximize throughput or to minimize ACLR. Next, the resolution of DAC and the bias current of PA will be set to new values. For example, to transmit using 16QAM, the resolution of DAC can be adjusted from 8 bits (the initial value that is set during the design step) to 5 bits with modifying the operating point of the PA without compromising the EVM budget This could lead to considerable reduction of power consumption in scenarios where the system is energy constrained. Another possibility would be that the DAC resolution is maintained at 8 bits and the PA operating point can be set such that it leads to higher ACLR and hence lower out of band emission, in scenarios where there are strict requirements on out of band emission and hence more linear operation of PA is desired.

In an example, the total EVM budget can be allocated to the PA and DAC as follows

EVM_{DAC}=θ×EVM

EVM_{PA}=(1−θ)×EVM

0<θ<1

where θ is an EVM-allocation parameter. The values zero and one are corresponding to the cases with an ideal DAC, and a completely linear PA, respectively. The parameter θ can be optimized for different scenarios with possibly different objective functions to achieve the best performance, i.e., improving the secondary objective, for a given total EVM budget such as the one illustrated in FIG. 6. Corresponding to each value of θ, the allocated EVM budget of the DAC and the PA can be specified as EVM_{DAC} and EVM_{PA}. Each value of EVM_{PA} can correspond to a PA with specific operating points, measured for example using IIP3. This dependency can be quantified for example based on the behavioral model of the PA. Each value of EVM_{DAC} can correspond to the specific number of bits for the DAC. This dependency can be quantified using the behavioral model of the DAC. Thus, the hardware parameters can be adjusted accordingly to achieve the EVM budget limit for each component, e.g., by selecting the number of bits for DAC and the bias current for PA for a given scenario which is specified by the scheduler. Throughput or energy consumption for a given EVM budget, for different values of the allocation factor θ can be optimized and a pair of configurations can be selected which optimizes the cost function, i.e., the secondary objective. For example, by solving the following optimization problem:

minimize_{st.EVM}_{_{DAC}}_{=θ×EVM,EVM}_{_{PA}}_{=(1-θ)×EVM}(E_{PA}(θ)+E_{DAC}(θ))

where E_{PA}(θ) is the energy consumption of the PA and E_{DAC}(θ) is the energy consumption of the DAC, and θ is the parameter to be optimized. An overview of this method is given in FIG. 5. Other objective functions can be considered for the optimization problem such as the throughput, or ACLR, where each of them will lead to different sets of hardware parameter settings. The parameters will be selected from the solution of one of these optimization problems depending on the decision of the scheduler. For example, when there is severe energy constraint in the system, the parameters will be selected based on the solution of the energy minimization problem, and when there are strict constraints for out of band emission, then the parameters will be selected based on the solution of the ACLR maximization problem.

As mentioned, the adapting S55 of the hardware configuration c2 of the PA 120 may be based on tabulated data of the PA. Such tabulated data of the PA comprises distortion contribution by the PA for different hardware configurations. Similarly, the adapting S56 of the hardware configuration c1 of the DAC 120 may be based on tabulated data of the DAC. Such the tabulated data of the DAC comprises distortion contribution by the DAC for different hardware configurations. The tabulated data can be gathered in a test environment where the transmitted signal is studied for a large number of hardware configurations. Searching the tabulated data to find hardware configurations that improve the secondary objective while meeting the signal quality requirements is a quick and effective process.

Any of the tabulated data may be dependent on a signal characteristic of the upcoming radio transmission. Signal characteristic can be frequency, bandwidth, MCS indices, power, number of layers etc. The tabulated data may further depend on the environment such as ambient and/or component temperature. Also, any of the tabulated data may be dynamically updated based on a feedback signal from the radio transmitter 100. This way, the tabulated data can maintain high accuracy even if conditions change, e.g., a change in loading conditions of the PA. This can further be used to gather the tabulated data in the first place. Alternatively, or in combination of, any of the tabulated data may be dynamically updated based on a feedback signal from a remote radio transceiver arranged to communicate with the radio transmitter 100. In other words, when the transmitted signal is received by a receiver in the communication system, the signal is analyzed and information that may be relevant is transmitted back to the radio transmitter 100, which in this case is comprised in a transceiver. Relevant information can be, e.g., that the signal quality requirement is not met with sufficient margin.

The tabulated data may comprise a high resolution of different values of the hardware configuration. However, the distortion contribution may be interpolated between discrete values of the hardware configuration to get a continuous function of the distortion contribution. This can improve accuracy and/or reduce the size of the table. The interpolation may, e.g., be obtained from a curve fitting function, where the curve to be fitted may be based on a behavioral model or on a purely mathematical model such as polynomial function.

Any of the tabulated data and the behavioral models may present a conservative estimation of distortion contribution of the PA or the DAC. In other words, the distortion contribution may be overestimated to some extent. This way, the signal quality requirement can always be met, even with less stringent requirements of the accuracy of the tabulated data or models.

The method may further comprise adapting S57 the hardware configuration c2 of the PA 120 based on a feedback signal from the radio transmitter 100, where the feedback signal comprises a current transmit signal quality. Similarly, the method may further comprise adapting S58 the hardware configuration c1 of the DAC 110 based on a feedback signal from the ratio transmitter 100, where the feedback signal comprises a current transmit signal quality. This way, the effectiveness of the method is surveyed in real time and can the method be adapted if conditions change. For example, the selection of the hardware configurations can be selected with a higher margin if the signal quality requirement in not met with sufficient margin.

As mentioned above, 3GPP also specifies requirements on other kinds of impairment metrics than EVM, such as ACLR. Therefore, the hardware configurations c1, c2 may be jointly adapted S52 while meeting a minimum requirement of a tertiary objective. The tertiary objective may comprise any of an energy consumption of the radio transmitter 100, a data throughput of the upcoming radio transmission, an output power of the upcoming radio transmission, a spectral efficiency of the upcoming radio transmission, and an ACLR of the upcoming radio transmission. Other tertiary objectives are also possible. In general, any performance metric affected by the hardware configuration c2 of the PA 120 and the hardware configuration c1 of the DAC 110 can be used as the tertiary objective. There may also be a minimum requirement of a plurality of performance metrics, such as the ones mentioned above.

The overall transmit signal quality requirement budget, e.g., EVM budget, may be composed of two parts: one part includes the contribution due to impairments from components that can be controlled, and the other part includes the contribution due to impairments that are fixed or cannot be controlled or may not be easy to control. Therefore, the method may further comprise determining S3 a distortion contribution by one or more non-configurable components in the radio transmitter 100. The maximum amount of distortion is in that case determined S41 in dependence of the distortion contribution by the one or more non-configurable components and the transmit signal quality requirement. Non-configurable components represent the fixed contributions and can be active filters or such. In other words, the non-configurable components are components which are not adapted to meet the signal quality requirement and the secondary objective. Another example of a non-configurable component is an oscillator in the radio transmitter. However, in some transmitters, the oscillator may have a hardware configuration c3 that can be adjusted to improve the secondary objective while meeting the signal quality requirement.

The method may further comprise jointly adapting S59 a hardware configuration c3 of an oscillator comprised in the radio transmitter 100 to generate an amount of distortion below the maximum amount of distortion, while improving the secondary objective of the radio transmitter. In some state-of-the-art radio transmitters, the radio oscillator is adapted towards changing peak power, peak modulation, and the number of co-scheduled MIMO streams. For example, a passive LC filter (inductor and capacitor) can be used to lower the phase noise in an oscillator. Adaptation of the filter can lead to different phase noise characteristics of the oscillator. In addition, the oscillator phase noise may be affected by specific environmental factors such as temperature.

The jointly adapting the hardware configuration c3 of the oscillator may be based on a behavior model of the oscillator. Such behavioral model of the oscillator models distortion contribution by the oscillator in dependence of the hardware configuration. Using behavioral modeling of the oscillator, the power error due to the oscillator phase noise can be specified, e.g., in terms of the carrier frequency (f_{c}), oscillator parameters, FFT size (N_{FFT}), PLL coefficient (λ), and sampling time (tₛ), and the EVM for oscillator can be specified as follows:

EVM_{OSC}={square root over (Pₑ_{_{OSC}}/P_{in,osc})}×100%=g(λ,f_{c},tₛ).

Alternatively, or in combination of, the adapting of the hardware configuration c3 of the oscillator may be based on tabulated data of the oscillator. Such tabulated data of the oscillator comprises distortion contribution by the oscillator for different hardware configurations.

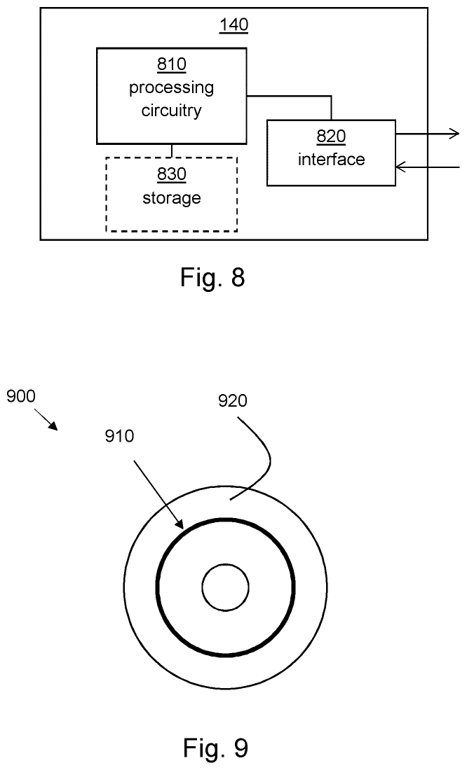

There is also disclosed herein a control unit 140 for jointly adapting hardware configurations c1, c2 of a power amplifier 120, PA, and a digital to analog converter 110, DAC, in a radio transmitter 100. The control unit comprises processing circuitry 810, a network interface 820 coupled to the processing circuitry 810, and a memory 830 coupled to the processing circuitry 810. The memory comprises machine readable computer program instructions that, when executed by the processing circuitry, causes the network node to perform the steps of obtaining a transmit signal quality requirement for an upcoming radio transmission, determining a maximum amount of distortion allowed to be contributed by the PA 120 and by the DAC 110 while meeting the transmit signal quality requirement, and jointly adapting the hardware configuration c2 of the PA 120 and the hardware configuration c1 of the DAC 110 to generate an amount of distortion below the maximum amount of distortion, while improving a secondary objective of the radio transmitter. FIG. 8 schematically illustrates, in terms of a number of functional units, the general components of such a control unit 140 according to embodiments of the discussions herein. Processing circuitry 810 is provided using any combination of one or more of a suitable central processing unit CPU, multiprocessor, microcontroller, digital signal processor DSP, etc., capable of executing software instructions stored in a computer program product, e.g., in the form of a storage medium 830. The processing circuitry 810 may further be provided as at least one application specific integrated circuit ASIC, or field programmable gate array FPGA.

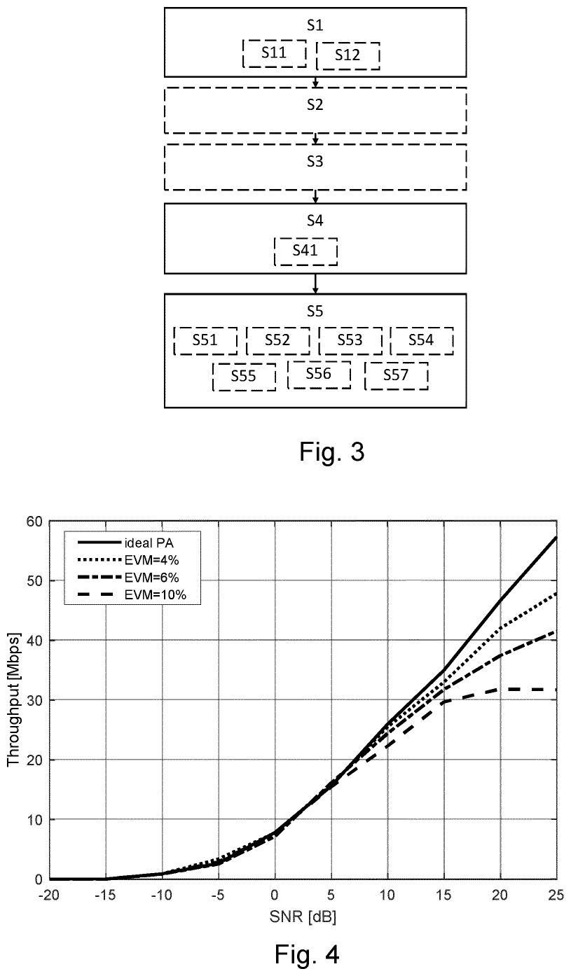

Particularly, the processing circuitry 810 is configured to cause the control unit 140 to perform a set of operations, or steps, such as the methods discussed in connection to FIGS. 3 and 5 and the discussions above. For example, the storage medium 830 may store the set of operations, and the processing circuitry 810 may be configured to retrieve the set of operations from the storage medium 830 to cause control unit to perform the set of operations. The set of operations may be provided as a set of executable instructions. Thus, the processing circuitry 810 is thereby arranged to execute methods as herein disclosed. In other words, there is shown control unit 140 comprising processing circuitry 810, a network interface 820 coupled to the processing circuitry 810 and a memory 830 coupled to the processing circuitry 810, wherein the memory comprises machine readable computer program instructions that, when executed by the processing circuitry, causes the control unit 140 to perform operations as discussed herein.

The storage medium 830 may also comprise persistent storage, which, for example, can be any single one or combination of magnetic memory, optical memory, solid state memory or even remotely mounted memory.

The control unit 140 may further comprise an interface 820 for communications with at least one external device. As such the interface 820 may comprise one or more transmitters and receivers, comprising analogue and digital components and a suitable number of ports for wireline or wireless communication.

The processing circuitry 810 controls the general operation of the control unit 140 e.g., by sending data and control signals to the interface 820 and the storage medium 830, by receiving data and reports from the interface 820, and by retrieving data and instructions from the storage medium 830. Other components, as well as the related functionality, of the control node are omitted in order not to obscure the concepts presented herein.

FIG. 9 illustrates a computer readable medium 920 carrying a computer program comprising program code means 910 for performing the methods illustrated in, e.g., FIGS. 3 and 5, when said program product is run on a computer. The computer readable medium and the code means may together form a computer program product 900.

1. A method for jointly adapting hardware configurations of a power amplifier (PA) and a digital to analog converter (DAC) in a radio transmitter, the method comprising:
obtaining a transmit signal quality requirement for an upcoming radio transmission;
determining a maximum amount of distortion allowed to be contributed by the PA and by the DAC while meeting the transmit signal quality requirement; and
jointly adapting the hardware configuration of the PA and the hardware configuration of the DAC to generate an amount of distortion below the maximum amount of distortion, while improving a secondary objective of the radio transmitter.

2. The method of claim 1, further comprising obtaining a relationship between hardware configuration and corresponding contributed distortion for the PA and for the DAC, wherein the hardware configurations are jointly adapted based on the obtained relationship between hardware configurations and corresponding contributed distortions.

3. The method of claim 1, further comprising determining a distortion contribution by one or more non-configurable components in the radio transmitter, where the maximum amount of distortion is determined in dependence of the distortion contribution by the one or more non-configurable components and the transmit signal quality requirement.

4. The method according of claim 1, where the secondary objective comprises any of
an energy consumption of the radio transmitter,
a data throughput of the radio transmission,
an output power of the radio transmission,
a spectral efficiency of the radio transmission, and
an adjacent channel leakage ratio, ACLR, of the upcoming radio transmission.

5. The method of claim 1, further comprising obtaining a transmit signal quality requirement comprising an error vector magnitude (EVM) requirement.

6. The method of claim 1, wherein the transmit signal quality requirement is determined in dependence of a modulation format of the upcoming radio transmission.

7. The method according to of claim 1, wherein the hardware configuration of the PA comprises a bias and/or an input power.

8. The method according of claim 1, wherein
the hardware configuration of the DAC comprises a resolution and/or a sampling rate, and
the resolution of the DAC comprises any of number of quantization bits, least significant bit configuration, and most significant bit configuration.

9. (canceled)

10. The method of claim 1, wherein
the hardware configurations are jointly adapted while meeting a minimum requirement of a tertiary objective, and
the tertiary objective comprises:
an energy consumption of the radio transmitter,
a data throughput of the upcoming radio transmission,
an output power of the upcoming radio transmission,
a spectral efficiency of the upcoming radio transmission, and/or
an ACLR of the upcoming radio transmission.

11. (canceled)

12. The method of claim 1, wherein jointly adapting the hardware configuration of the PA comprises adapting of the hardware configuration of the PA based on a behavior model of the PA, wherein the behavioral model of the PA models distortion contribution by the PA in dependence of the hardware configuration.

13. The method of claim 1, wherein
jointly adapting the hardware configuration of the DAC comprises adapting of the hardware configuration of the DAC based on a behavior model of the DAC,
the behavioral model of the DAC models distortion contribution by the DAC in dependence of the hardware configuration, and
any of the behavioral models is further dependent on a signal characteristic of the upcoming radio transmission.

14. (canceled)

15. The method of claim 1, wherein the adapting of the hardware configuration of the PA is based on tabulated data of the PA, wherein the tabulated data of the PA comprises distortion contribution by the PA for different hardware configurations.

16. The method of claim 1, wherein the adapting of the hardware configuration of the DAC is based on tabulated data of the DAC, wherein the tabulated data of the DAC comprises distortion contribution by the DAC for different hardware configurations.

17. The method-according to of claim 15, wherein
any of the tabulated data is further dependent on a signal characteristic of the upcoming radio transmission,
any of the tabulated data is dynamically updated based on a feedback signal from the radio transmitter, or
any of the tabulated data is dynamically updated based on a feedback signal from a remote radio transceiver arranged to communicate with the radio transmitter.

18. (canceled)

19. (canceled)

20. The method of claim 1, wherein the method further comprises adapting the hardware configuration of the PA based on a feedback signal from the radio transmitter, wherein the feedback signal comprises a current transmit signal quality.

21. The method of claim 1, wherein the method further comprises adapting the hardware configuration of the DAC based on a feedback signal from the ratio transmitter, wherein the feedback signal comprises a current transmit signal quality.

22. The method according of claim 1, further comprising jointly adapting a hardware configuration of an oscillator comprised in the radio transmitter to generate an amount of distortion below the maximum amount of distortion, while improving the secondary objective of the radio transmitter.

23. A non-transitory computer readable storage medium storing a computer program comprising program code means for performing the method of claim 1.

24. (canceled)

25. A control unit for jointly adapting hardware configurations of a power amplifier (PA) and a digital to analog converter (DAC) in a radio transmitter, the control unit comprising:
processing circuitry;
a network interface coupled to the processing circuitry; and
a memory coupled to the processing circuitry, wherein the memory comprises machine readable computer program instructions that, when executed by the processing circuitry, causes the network node to perform a method comprising:
obtaining a transmit signal quality requirement for an upcoming radio transmission,
determining a maximum amount of distortion allowed to be contributed by the PA and by the DAC while meeting the transmit signal quality requirement, and
jointly adapting the hardware configuration of the PA and the hardware configuration of the DAC to generate an amount of distortion below the maximum amount of distortion, while improving a secondary objective of the radio transmitter.
